(19) United States
(12) Patent Application Publication
(10) Pub. No.: US 2015/0311594 A1
(43) Pub. Date: Oct. 29, 2015

(54) Electronic Devices With Hybrid Antennas

(71) Applicant: Apple Inc., Cupertino, CA (US)

(72) Inventors: Jiang Zhu, Sunnyvale, CA (US); Rodney A. Gomez Angulo, Sunnyvale, CA (US); Qingxiang Li, Mountain View, CA (US); Robert W. Schlub, Cupertino, CA (US); Hongfei Hu, Santa Clara, CA (US)

(73) Assignee: Apple Inc., Cupertino, CA (US)

(21) Appl. No.: 14/260,800

(22) Filed: Apr. 24, 2014

(51) Int. Cl. H01Q 13/10; H01Q 1/22; H01Q 1/24

(52) U.S. Cl. CPC H01Q 13/10; H01Q 1/243; H01Q 1/2258

(57) ABSTRACT

An electronic device may be provided with hybrid planar inverted-F slot antennas and indirectly fed slot antennas. A hybrid antenna may be used to form a dual band wireless local area network antenna. An indirectly fed slot antenna may be use to form a cellular telephone antenna. Antenna slots may be formed in a metal electronic device housing wall. The housing wall may have a planar rear portion and sidewall portions that extend upwards from the planar rear portion. The slots may have one or more bends. A hybrid antenna may have a slot antenna portion and a planar inverted-F antenna portion. The planar inverted-F antenna portion may have a metal resonating element patch that is supported by a support structure. The support structure may be a plastic speaker box containing a speaker driver that is not overlapped by the metal resonating element patch.

### BACKGROUND

This relates generally to electronic devices and, more particularly, to electronic devices with antennas.

Electronic devices often include antennas. For example, cellular telephones, computers, and other devices often contain antennas for supporting wireless communications.

It can be challenging to form electronic device antenna structures with desired attributes. In some wireless devices, the presence of conductive housing structures can influence antenna performance. Antenna performance may not be satisfactory if the housing structures are not configured properly and interfere with antenna operation. Device size can also affect performance. It can be difficult to achieve desired performance levels in a compact device, particularly when the compact device has conductive housing structures.

It would therefore be desirable to be able to provide improved wireless circuitry for electronic devices such as electronic devices that include conductive housing structures.

### SUMMARY

An electronic device may be provided with wireless circuitry. The wireless circuitry may include radio-frequency transceiver circuitry and one or more antennas. Antennas for the electronic device may be formed from hybrid planar inverted-F slot antenna structures and indirectly fed slot antennas.

A hybrid antenna may be used to form a dual band wireless local area network antenna. An indirectly fed slot antenna may be use to form a cellular telephone antenna. Arrays of multiple hybrid antennas may also be formed.

A hybrid antenna may have a slot antenna portion and a planar inverted-F antenna portion. The planar inverted-F antenna portion may have a metal resonating element patch that is supported by a support structure. The support structure may be a plastic speaker box containing a speaker driver that is not overlapped by the metal resonating element patch.

Antenna slots for the antennas in the electronic device may be formed in a metal electronic device housing wall. The housing wall may have a planar rear portion and sidewall portions that extend upwards from the planar rear portion. The slots may have one or more bends and may be filled with plastic. Slots may also be formed in metal traces on a printed circuit or other metal structures.

### BRIEF DESCRIPTION OF THE DRAWINGS

FIG. 1 is a perspective view of an illustrative electronic device such as a laptop computer in accordance with an embodiment.

FIG. 2 is a perspective view of an illustrative electronic device such as a handheld electronic device in accordance with an embodiment.

FIG. 3 is a perspective view of an illustrative electronic device such as a tablet computer in accordance with an embodiment.

FIG. 4 is a perspective view of an illustrative electronic device such as a display for a computer or television in accordance with an embodiment.

FIG. 5 is a schematic diagram of illustrative circuitry in an electronic device in accordance with an embodiment.

FIG. 6 is a schematic diagram of illustrative wireless circuitry in accordance with an embodiment.

FIG. 7 is a diagram of an illustrative inverted-F antenna structure in accordance with an embodiment.

FIG. 8 is a perspective view of an illustrative planar inverted-F antenna structure in accordance with an embodiment.

FIG. 9 is a top view of an illustrative closed slot antenna structure in accordance with an embodiment.

FIG. 10 is a top view of an illustrative open slot antenna structure in accordance with an embodiment.

FIG. 11 is a perspective view of an illustrative hybrid planar inverted-F slot antenna in accordance with an embodiment.

FIG. 12 is a graph in which antenna performance (standing wave ratio) has been plotted against operating frequency for an illustrative hybrid planar inverted-F slot antenna in accordance with an embodiment.

FIG. 13 is a perspective view of another illustrative hybrid planar inverted-F slot antenna in accordance with an embodiment.

FIG. 14 is a perspective view of a portion of an electronic device with multiple antennas in accordance with an embodiment.

FIG. 15 is a cross-sectional side view of an illustrative speaker box in accordance with an embodiment.

FIG. 16 is a perspective view of an illustrative end portion of an electronic device in which antenna structures for a hybrid antenna are being supported by a speaker box of the type shown in FIG. 15 in accordance with an embodiment.

### DETAILED DESCRIPTION

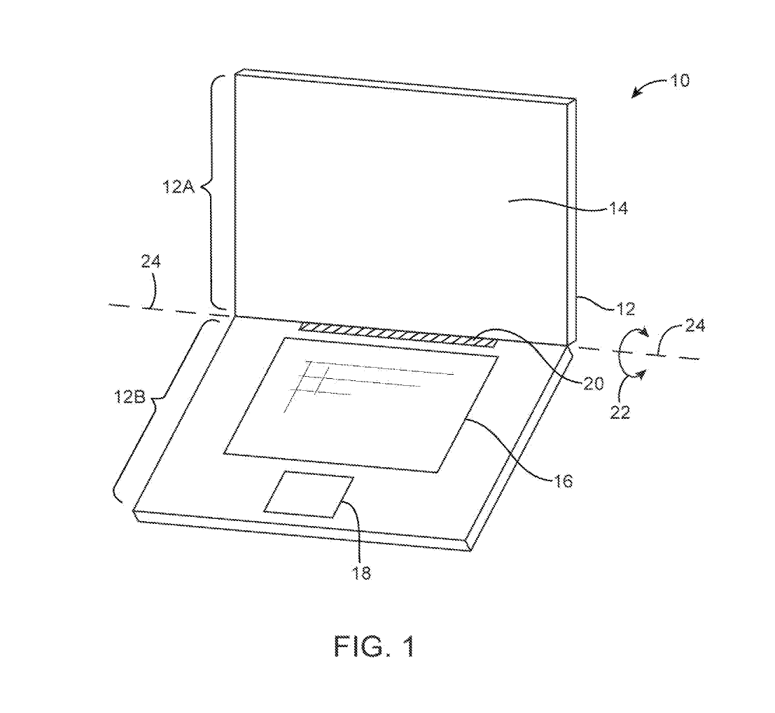

Electronic devices may be provided with antennas. The antennas may include slot antenna structures and/or other antenna structures such as inverted-F antenna structures (e.g., planar inverted-F antenna structures). Hybrid antennas and indirectly fed antennas may be formed. For example, a hybrid planar inverted-F slot antenna may be formed by incorporating both planar inverted-F antenna structures and slot antenna structures into an antenna. Slots for antennas can be formed in device structures such as electronic device housing structures. Illustrative electronic devices that have housings that accommodate slot antenna structures, hybrid antennas, and other wireless circuitry are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

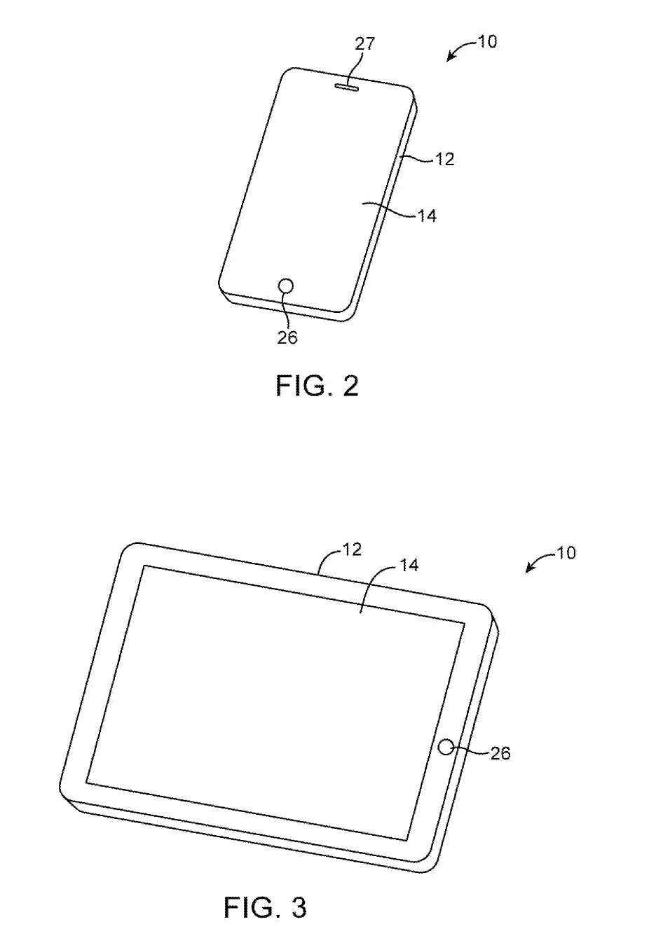

FIG. 2 shows an illustrative configuration for electronic device 10 based on a handheld device such as a cellular telephone, music player, gaming device, navigation unit, or other compact device. In this type of configuration for device 10, device 10 has opposing front and rear surfaces. The rear surface of device 10 may be formed from a planar portion of housing 12. Display 14 forms the front surface of device 10. Display 14 may have an outermost layer that includes openings for components such as button 26 and speaker port 27.

In the example of FIG. 3, electronic device 10 is a tablet computer. In electronic device 10 of FIG. 3, device 10 has opposing planar front and rear surfaces. The rear surface of device 10 is formed from a planar rear wall portion of housing 12. Curved or planar sidewalls may run around the periphery of the planar rear wall and may extend vertically upwards. Display 14 is mounted on the front surface of device 10 in housing 12. As shown in FIG. 3, display 14 has an outermost layer with an opening to accommodate button 26.

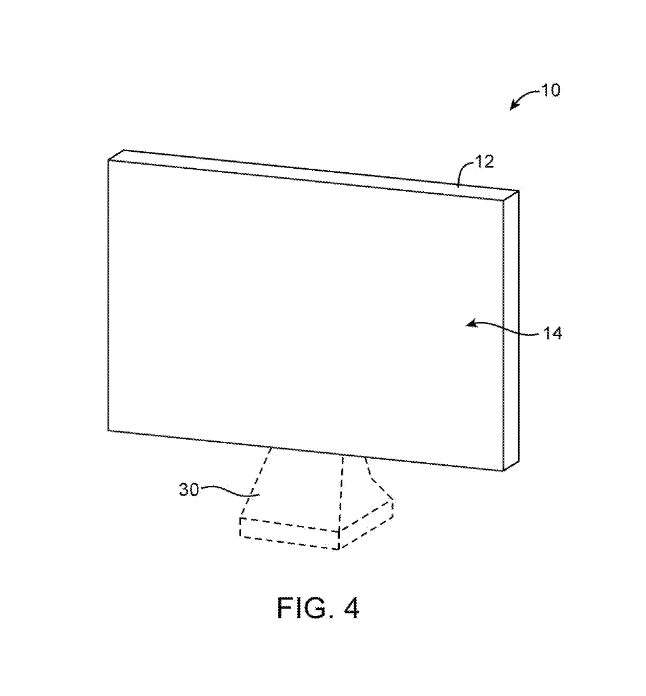

FIG. 4 shows an illustrative configuration for electronic device 10 in which device 10 is a computer display, a computer that has an integrated computer display, or a television. Display 14 is mounted on a front face of device 10 in housing 12. With this type of arrangement, housing 12 for device 10 may be mounted on a wall or may have an optional structure such as support stand 30 to support device 10 on a flat surface such as a tabletop or desk.

An electronic device such as electronic device 10 of FIGS. 1, 2, 3, and 4, may, in general, be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. The examples of FIGS. 1, 2, 3, and 4 are merely illustrative.

Device 10 may include a display such as display 14. Display 14 may be mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies.

Display 14 may be protected using a display cover layer such as a layer of transparent glass or clear plastic. Openings may be formed in the display cover layer. For example, an opening may be formed in the display cover layer to accommodate a button, an opening may be formed in the display cover layer to accommodate a speaker port, etc.

Housing 12 may be formed from conductive materials and/or insulating materials. In configurations in which housing 12 is formed from plastic or other dielectric materials, antenna signals can pass through housing 12. Antennas in this type of configuration can be mounted behind a portion of housing 12. In configurations in which housing 12 is formed from a conductive material (e.g., metal), it may be desirable to provide one or more radio-transparent antenna windows in openings in the housing. As an example, a metal housing may have openings that are filled with plastic antenna windows. Antennas may be mounted behind the antenna windows and may transmit and/or receive antenna signals through the antenna windows.

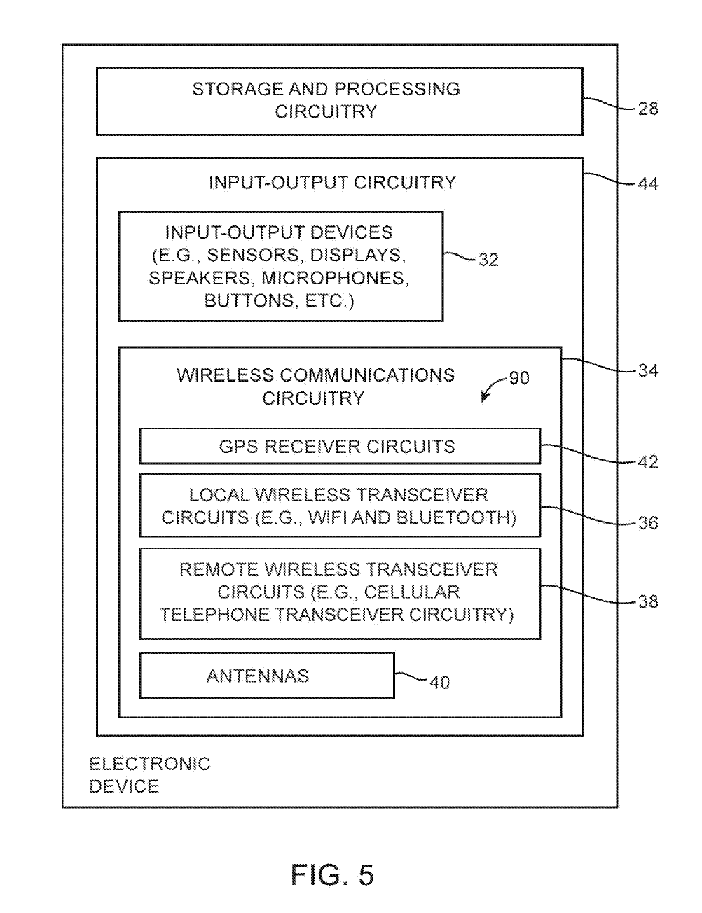

A schematic diagram showing illustrative components that may be used in device 10 is shown in FIG. 5. As shown in FIG. 5, device 10 may include control circuitry such as storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, cellular telephone protocols, MIMO protocols, antenna diversity protocols, etc.

Input-output circuitry 44 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc.

Input-output circuitry 44 may include wireless communications circuitry 34 for communicating wirelessly with external equipment. Wireless communications circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless communications circuitry 34 may include radio-frequency transceiver circuitry 90 for handling various radio-frequency communications bands. For example, circuitry 34 may include transceiver circuitry 36, 38, and 42. Transceiver circuitry 36 may be wireless local area network transceiver circuitry that may handle 2.4 GHz and 5 GHz bands for WiFi® (IEEE 802.11) communications and that may handle the 2.4 GHz Bluetooth® communications band. Circuitry 34 may use cellular telephone transceiver circuitry 38 for handling wireless communications in frequency ranges such as a low communications band from 700 to 960 MHz, a midband from 1710 to 2170 MHz, and a high band from 2300 to 2700 MHz or other communications bands between 700 MHz and 2700 MHz or other suitable frequencies (as examples). Circuitry 38 may handle voice data and non-voice data. Wireless communications circuitry 34 can include circuitry for other short-range and long-range wireless links if desired. For example, wireless communications circuitry 34 may include 60 GHz transceiver circuitry, circuitry for receiving television and radio signals, paging system transceivers, near field communications (NFC) circuitry, etc. Wireless communications circuitry 34 may include satellite navigation system circuitry such as global positioning system (GPS) receiver circuitry 42 for receiving GPS signals at 1575 MHz or for handling other satellite positioning data. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 34 may include antennas 40. Antennas 40 may be formed using any suitable antenna types. For example, antennas 40 may include antennas with resonating elements that are formed from loop antenna structures, patch antenna structures, inverted-F antenna structures, slot antenna structures, planar inverted-F antenna structures, helical antenna structures, hybrids of these designs, etc. Different types of antennas may be used for different bands and combinations of bands. For example, one type of antenna may be used in forming a local wireless link antenna and another type of antenna may be used in forming a remote wireless link antenna.

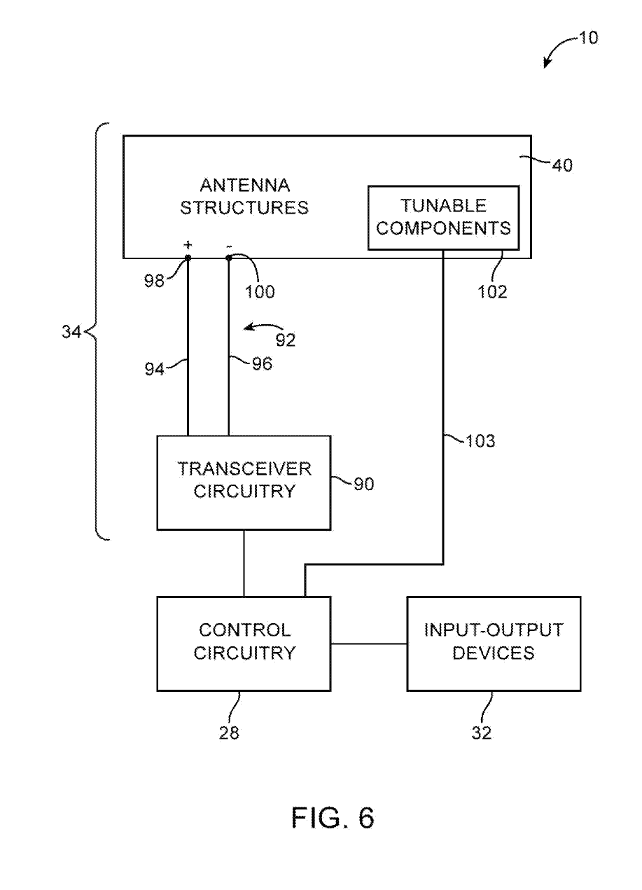

As shown in FIG. 6, transceiver circuitry 90 in wireless circuitry 34 may be coupled to antenna structures 40 using paths such as path 92. Wireless circuitry 34 may be coupled to control circuitry 28. Control circuitry 28 may be coupled to input-output devices 32. Input-output devices 32 may supply output from device 10 and may receive input from sources that are external to device 10.

To provide antenna structures 40 with the ability to cover communications frequencies of interest, antenna structures 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna structures 40 may be provided with adjustable circuits such as tunable components 102 to tune antennas over communications bands of interest. Tunable components 102 may include tunable inductors, tunable capacitors, or other tunable components. Tunable components such as these may be based on switches and networks of fixed components, distributed metal structures that produce associated distributed capacitances and inductances, variable solid state devices for producing variable capacitance and inductance values, tunable filters, or other suitable tunable structures.

During operation of device 10, control circuitry 28 may issue control signals on one or more paths such as path 104 that adjust inductance values, capacitance values, or other parameters associated with tunable components 102, thereby tuning antenna structures 40 to cover desired communications bands.

Path 92 may include one or more transmission lines. As an example, signal path 92 of FIG. 6 may be a transmission line having a positive signal conductor such as line 94 and a ground signal conductor such as line 96. Lines 94 and 96 may form parts of a coaxial cable or a microstrip transmission line (as examples). A matching network formed from components such as inductors, resistors, and capacitors may be used in matching the impedance of antenna structures 40 to the impedance of transmission line 92. Matching network components may be provided as discrete components (e.g., surface mount technology components) or may be formed from housing structures, printed circuit board structures, traces on plastic supports, etc. Components such as these may also be used in forming filter circuitry in antenna structures 40.

Transmission line 92 may be directly coupled to an antenna resonating element and ground for antenna 40 or may be coupled to near-field-coupled antenna feed structures that are used in indirectly feeding a resonating element for antenna 40. As an example, antenna structures 40 may form an inverted-F antenna, a slot antenna, a hybrid inverted-F slot antenna or other antenna having an antenna feed with a positive antenna feed terminal such as terminal 98 and a ground antenna feed terminal such as ground antenna feed terminal 100. Positive transmission line conductor 94 may be coupled to positive antenna feed terminal 98 and ground transmission line conductor 96 may be coupled to ground antenna feed terminal 92. As another example, antenna structures 40 may include an antenna resonating element such as a slot antenna resonating element or other element that is indirectly fed using near-field coupling. In a near-field coupling arrangement, transmission line 92 is coupled to a near-field-coupled antenna feed structure that is used to indirectly feed antenna structures such as an antenna slot or other element through near-field electromagnetic coupling.

Antennas 40 may include hybrid antennas formed both from inverted-F antenna structures (e.g., planar inverted-F antenna structures) and slot antenna structures.

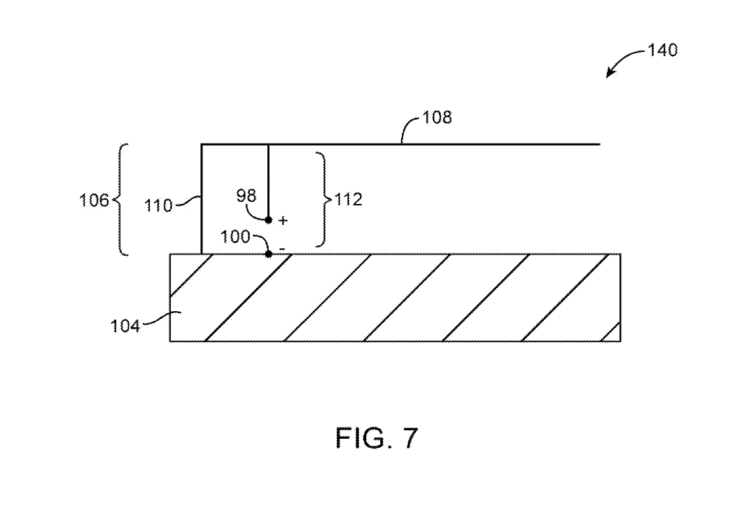

An illustrative inverted-F antenna structure is shown in FIG. 7. Inverted-F antenna structure 140 of FIG. 7 has antenna resonating element 106 and antenna ground (ground plane) 104. Antenna resonating element 106 may have a main resonating element arm such as arm 108. The length of arm 108 may be selected so that antenna structure 140 resonates at desired operating frequencies. For example, if the length of arm 108 may be a quarter of a wavelength at a desired operating frequency for antenna 40. Antenna structure 140 may also exhibit resonances at harmonic frequencies.

Main resonating element arm 108 may be coupled to ground 104 by return path 110. Antenna feed 112 may include positive antenna feed terminal 98 and ground antenna feed terminal 100 and may run in parallel to return path 110 between arm 108 and ground 104. If desired, inverted-F antenna structures such as illustrative antenna structure 140 of FIG. 7 may have more than one resonating arm branch (e.g., to create multiple frequency resonances to support operations in multiple communications bands) or may have other antenna structures (e.g., parasitic antenna resonating elements, tunable components to support antenna tuning, etc.). A planar inverted-F antenna (PIFA) may be formed by implementing arm 108 using planar structures (e.g., a planar metal structure such as a metal patch or strip of metal that extends into the page of FIG. 7).

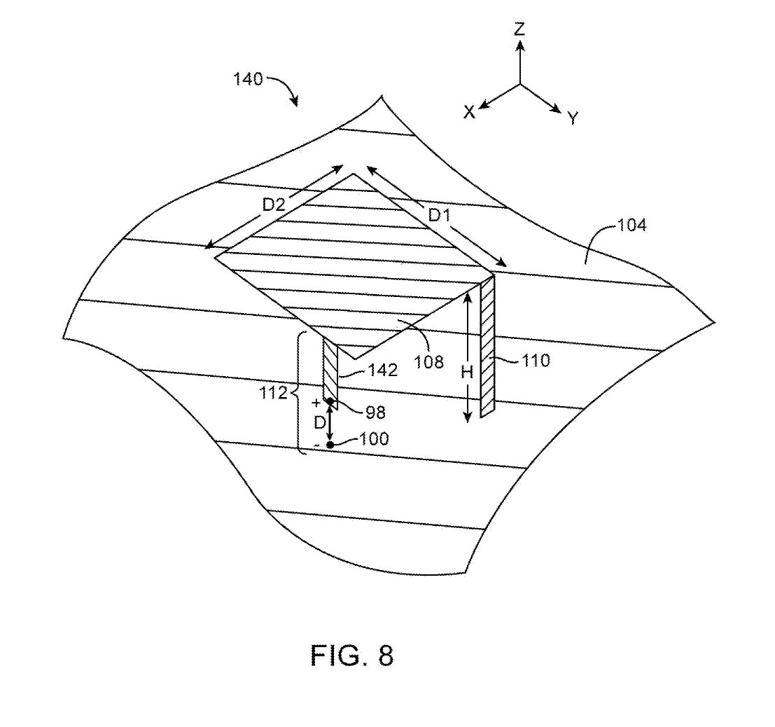

FIG. 8 is a perspective view of an illustrative planar inverted-F antenna structure. As shown in FIG. 8, planar inverted-F antenna structures 140 have an antenna feed such as feed 112 that includes a downwardly protruding feed leg such as leg 142. Positive antenna feed terminal 98 may be coupled to leg 142. Ground antenna feed terminal 100 may be coupled to ground 104 and may be separated from terminal 98 by distance D. Return path (short circuit path) 100 is formed from leg 110 and couples planar resonating element “arm” structure 108 (e.g., a metal patch) to ground plane 104. Structure 108 is preferably planar and lies in a plane that is parallel to the plane of ground 104. Structure 108 may have a rectangular plate (patch) shape with lateral dimensions D1 and D2 (as an example). Configurations in which structure 108 has a meandering arm shape, shapes with multiple branches, or other shapes may also be used for planar inverted-F antenna structures 140. Planar inverted-F antenna structures such as structures 140 of FIG. 8 may be used in a hybrid planar inverted-F slot antenna.

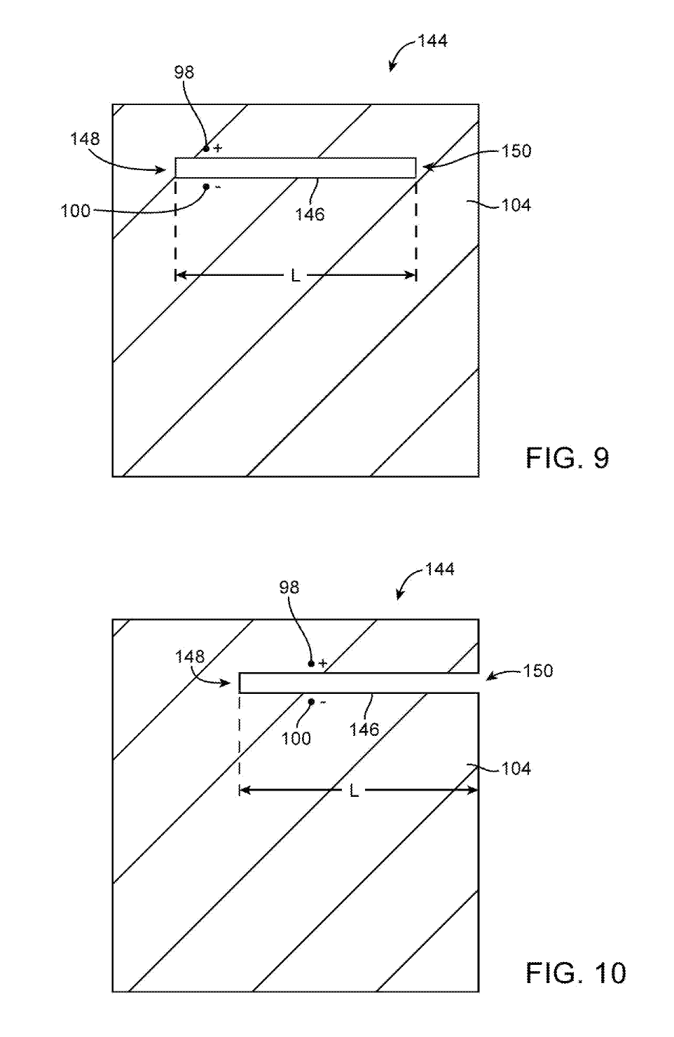

Illustrative slot antenna structures of the type that may be used in forming antennas 40 in device 10 are shown in FIGS. 9 and 10.

Slot antenna structures 144 of FIG. 9 have a closed slot. As shown in FIG. 9, slot 146 is formed from an opening in ground plane 104 and is bridged by antenna feed terminals 98 and 100. Slot 146 has an elongated shape (e.g., a rectangular shape) with respective ends 148 and 150. End 148 of slot 146 is surrounded by portions of ground plane 104 (e.g., end 148 of slot 146 is enclosed by metal). End 150 of slot 146 is also surrounded by portions of ground plane 104. Because both ends of slot 146 are enclosed by metal, slot 146 is surrounded by metal in ground plane 104. Slots such as illustrative slot 146 of FIG. 9 that have two closed ends are sometimes referred to closed slots (i.e., antenna structures 144 are closed slot antenna structures). Slot 146 may be filled with air, plastic, and/or other dielectric and may have one or more bends.

Slot antenna structures 144 of FIG. 10 have an open slot. As shown in FIG. 10, slot 146 is formed from an opening in ground plane 104 and is bridged by antenna feed terminals 98 and 100. Slot 146 of FIG. 10 may be filled with air, plastic, and/or other dielectric and may have one or more bends.

Slot 146 of FIG. 10 has an elongated shape (e.g., a rectangular shape) with respective ends 148 and 150. End 148 of slot 146 is surrounded by portions of ground plane 104 (e.g., end 148 of slot 146 is enclosed by metal) and is therefore sometimes referred to as forming a closed slot end. End 150 of slot 146 is not surrounded by portions of ground plane 104, but rather is open to surrounding air and/or other dielectric. Ends such as end 150 may sometimes be referred to as open slot ends. Slots such as slot 146 that have one closed end (end 148) and one open end (end 150) are sometimes referred to as open slots (i.e., slot antenna structures 144 of FIG. 10 are open slot antenna structures). The length of an open slot antenna may be about half of the length of a closed slot antenna when being configured to operate at a given frequency, so open slot antennas may sometimes be preferred in compact electronic devices or devices in which it is otherwise desirable to minimize slot length.

If desired, slots 146 for antenna structures 144 may have other shapes. For example, slots 146 may have a shapes with a single bend, shapes with one or more bends, shapes with two or more bends, shapes with locally widened portions, etc. Slots 146 of FIGS. 9 and 10 are merely illustrative. Ground plane 104 of slot antenna structures 140 may be formed from metal traces on a printed circuit or plastic carrier, metal traces on other substrates, metal that forms part of an external housing wall or other portion of a metal housing (see, e.g., housing 12, which may have a planar rear wall portion and vertically extending sidewall portions), metal that forms part of an electronic device, part of an internal housing structure, part of a metal bracket or other internal support structure, or other conductive structures in device 10. Slots 146 may be filled with plastic (e.g., to prevent intrusion of dust and other substances into the interior of device 10 in a configuration in which slots 146 are formed in a metal housing such as housing 12 for device 10). Some or all of slots 146 may also be filled with other dielectric materials (e.g., air, glass, ceramic, etc.).

The performance of planar inverted-F antenna (PIFA) structures 140 of FIG. 8 may be adjusted by adjusting the shape of resonating element 108 (e.g., by adjusting lateral dimensions D1 and/or D2 or other attributes of resonating element 108). The performance of slot antenna structures 144 may be adjusted by adjusting the size of slot 146 (e.g., by adjusting the perimeter of the slot). In narrow slots, for example, the resonance of a slot antenna structure will be influenced by adjustment of longitudinal dimension (length L) of slot 146, because the perimeter of a narrow slot is about equal to twice its length.

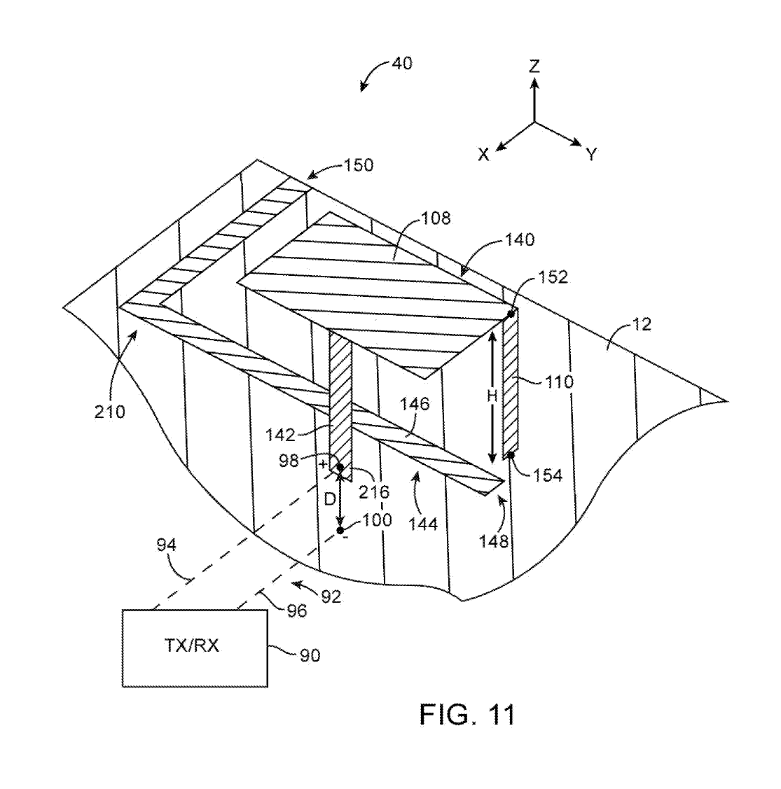

Antenna(s) 40 of device 10 may be formed using hybrid planar inverted-F slot antenna(s). An illustrative hybrid PIFA slot antenna is shown in FIG. 11. Hybrid antenna 40 of FIG. 11 is formed from both slot antenna structures 144 and planar inverted-F antenna structures 140.

Illustrative hybrid planar inverted-F slot antenna 40 of FIG. 11 has an antenna ground (ground 104 of FIGS. 8, 9, and 10) that has been formed from metal housing 12. Metal traces and/or other conductive structures may also be used in forming an antenna ground for hybrid antenna 40. The configuration of FIG. 11 in which metal electronic device housing 12 forms an antenna ground is merely illustrative. A ground plane may also be formed using metal traces on printed circuits, etc.

Slot 146 of FIG. 11 may be formed in ground plane 12. Slot 146 may be filled with plastic or other dielectric. In the example of FIG. 11, slot 146 has an open end such as end 150 and an opposing closed end such as closed end 148. If desired, slot 146 may be a closed slot. Slot 146 has bend 210. If desired, slot 146 may be provided with two bends, three or more bends, etc. The example of FIG. 11 is merely illustrative.

In addition to slot antenna structures 144 formed from slot 146, antenna 40 has planar inverted-F antenna structures 140. Planar inverted-F antenna structures 140 may include resonating element structure 108 (e.g., a patch of metal). Patch 108 may have portions that protrude downwardly towards ground 12 such as leg 142 and leg 110. Leg 142 may form part the feed for antenna 40. Tip 216 of leg 142 is separated from ground plane 12 by a dielectric gap such as air gap D (i.e., tip 216 is not directly connected to ground 12). Return path 110 is coupled to patch 108 at connection point 152 and is connected to ground 12 at connection point 154.

Transceiver circuitry 90 is coupled to antenna feed terminals such as terminals 98 and 100 by transmission line 92. Terminal 98 may be connected to tip portion 216 of leg 142. Terminal 100 may be connected to ground structure 12. Positive signal line 94 may be coupled to terminal 98. Ground signal line 96 may be coupled to terminal 100.

Planar inverted-F antenna structures 140 are directly fed by the transmission line coupled to terminals 98 and 100. Through near-field electromagnetic coupling and/or by providing antenna feed signals across slot 146 through structures 140, planar inverted-F antenna structures 140 are coupled to slot antenna structures 146. As a result, both slot antenna structures 145 and planar inverted-F antenna structures 140 contribute to the overall performance of hybrid antenna 40.

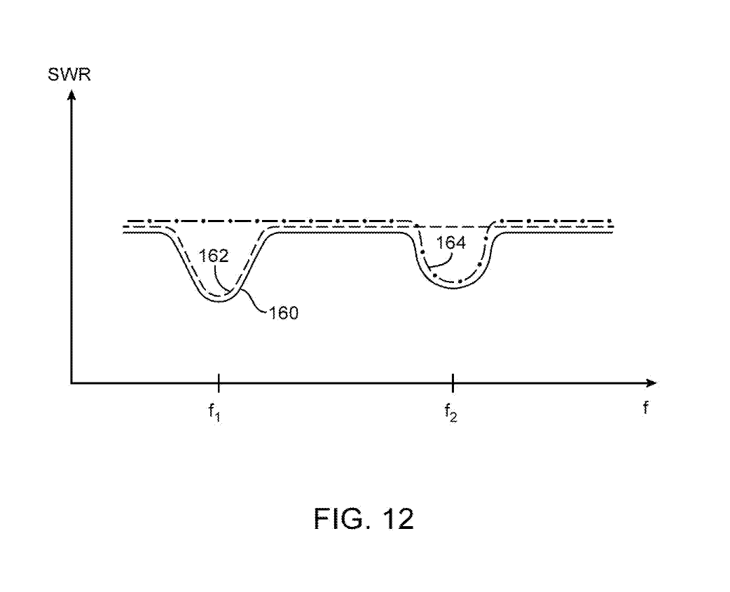

FIG. 12 is a graph in which antenna performance (standing-wave ratio SWR) for the antenna structures of FIG. 11 has been plotted as a function of antenna signal operating frequency f. Curve 164 corresponds to the response of planar inverted-F antenna structures 140. Curve 164 may exhibit an antenna resonance at frequency f2. The position of the resonance at frequency f2 may be adjusted by adjusting the lateral dimensions of patch 108 (as an example). Curve 162 corresponds to the response of slot antenna structures 144. Curve 162 may exhibit an antenna resonance at frequency f1. The position of the resonance at frequency f1 may be adjusted by adjusting the length of slot 146 in slot antenna structures 144. The overall performance of antenna structures 40 is given by curve 160. As shown in FIG. 12, curve 160 reflects contributions from both slot antenna structures 144 and from planar inverted-F antenna structures 140. Curve 160 may, for example, have a first resonance at f1 that is influenced by the characteristics of slot antenna structures 144 and may have a second resonance at f2 that is influenced by the characteristics of planar inverted-F antenna structures 140.

The use of the hybrid antenna arrangement for antenna 40 allows the advantages of the planar inverted-F antenna portion of antenna 40 to be exploited at frequency f2 (i.e., the ability of planar inverted-F antenna structures 140 to exhibit good antenna efficiency and high bandwidth at frequency f2), while allowing the advantages of the slot antenna portion of antenna 40 to be exploited at frequency f1 (i.e., the ability of slot antenna structures 144 to exhibit good antenna efficiency and bandwidth at frequency f1).

With one suitable arrangement, antenna 40 may be a dual band antenna for wireless local area network signals (e.g., IEEE 802.11 signals), frequency f2 may be 5 GHz, and frequency f1 may be 2.4 GHz. In this type of arrangement, PIFA structures 140 may be efficient at 5 GHz, but may not be as efficient at 2.4 GHz, particularly in configurations in which vertical height H of patch 108 above ground plane 12 is limited (e.g., in compact devices where available antenna height is constrained), whereas slot antenna structures 146 may be efficient at 2.4 GHz. The complementary nature of hybrid antenna 40 allows the positive attributes of each type of antenna to be used, thereby ensuring that both the low band (f1) and high band (f2) ranges are effectively covered by antenna 40.

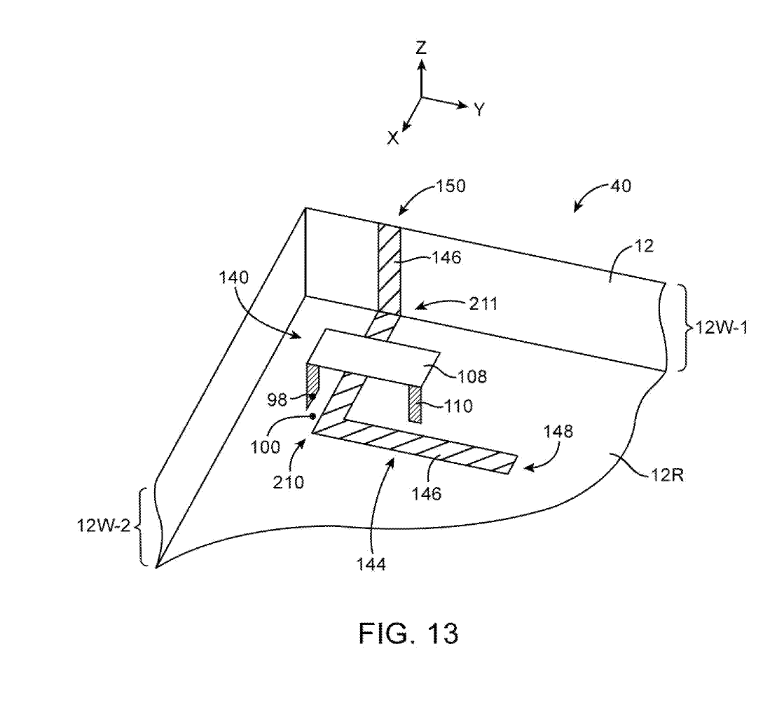

Another illustrative arrangement for hybrid antenna 40 is shown in FIG. 13. As shown in FIG. 13, housing 12 may have planar rear wall portion 12R and sidewalls such as vertical sidewalls 12W-1 and 12W-2. Sidewalls 12W-1 and 12W-2 may be flat or curved. Slot 146 may extend away from planar rear wall 12R and up a sidewall such as sidewall 12W-1 in dimension Z. Slot 146 may have two bends such as bends 211 and 210 or may have other shapes. Antenna feed terminals 98 and 100 may be formed on the edge of slot 146 nearest sidewall 12W-1 and return path 110 may be formed on the opposing edge of slot 146.

Antennas such as hybrid antenna 40 may be used in an array of two or more antennas. For example, a first antenna such as antenna 40 of FIG. 13 may be formed along one portion of an edge of device 10 and a second antenna such as antenna 40 of FIG. 13 may be formed along a second portion of the edge of device 10. The antennas may be used in a multiple-input-multiple output (MIMO) array or other array (e.g., for wireless local area networking or other wireless communications). If desired, device 10 may contain one or more antennas such as antenna 40 (e.g., for wireless local area network communications) and one or more cellular telephone antennas, satellite navigation system antennas, etc.

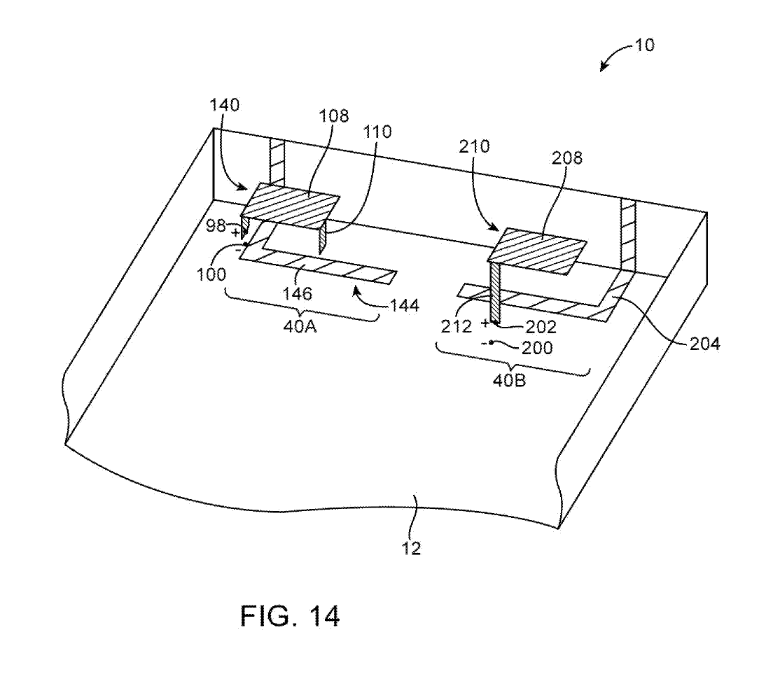

As an example, device 10 of FIG. 14 has first antenna 40A and second antenna 40B. Antenna 40A may be a hybrid planar inverted-F slot antenna (see, e.g., antenna 40 of FIG. 13). Antenna 40A may have planar inverted-F antenna structures 140 formed from patch resonating element 108, return path 110, and feed terminals 98 and 100. Antenna 40A may also have slot antenna structures 144 formed from slot 146 in ground plane 12 (e.g., a metal housing for device 10). Antenna 40A may be used for wireless local area network communications. For example, antenna 40A may be a dual band antenna covering signals at a low band of 2.4 GHz and a high band at 5 GHz.

Antenna 40B may be an indirectly fed cellular telephone antenna. Antenna 40B may be a slot antenna having a slot such as slot 204 in a ground formed from metal housing 12 or other metal structures. Antenna 40B may be fed using a near-field coupled feed structure such as structure 210. Structure 210 may, as an example, have a patch such as metal patch 208. A transmission line may have a positive signal line coupled to positive feed terminal 202 on leg 212 of feed structure 210 and may have a ground line coupled to ground feed terminal 200 on ground 12. The transmission line may convey signals for antenna 40B to feed structure 210. Feed structure 210 may be electromagnetically coupled to slot 204 through near field electromagnetic coupling (i.e., structure 210 may indirectly feed a slot antenna formed from slot 204). Slot 204 may be an open slot (as an example). Antenna 40B may be used in handling cellular telephone signals at frequencies of 700-2700 MHz or other suitable frequencies.

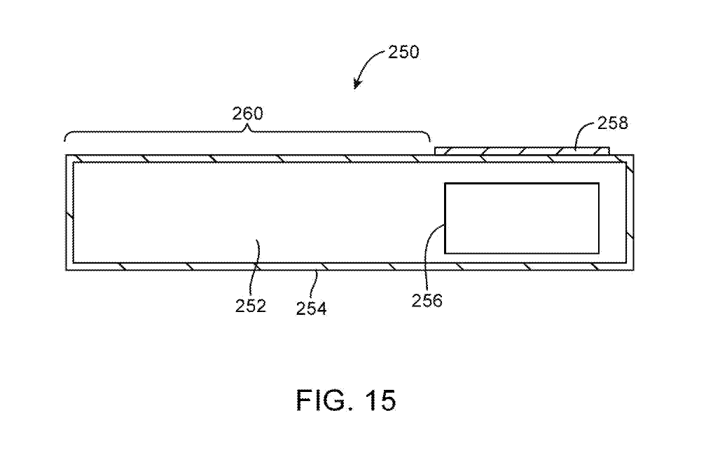

If desired, antenna structures for antenna 40 may be supported using a plastic support structure. The plastic support structure may also serve as a speaker cavity (sometimes referred to as a speaker box). A cross-sectional side view of an illustrative speaker box for device 10 is shown in FIG. 15. As shown in FIG. 15, speaker box 250 may have speaker box cavity 252 formed within speaker box wall structure 254. Wall structure 254 may be a hollow plastic box and may have an acoustic port covered with mesh to prevent the intrusion of dust and moisture while allowing sound to escape from air-filled cavity 252 within the box. Speaker driver 256 may be located within cavity 252. Optional metal structure 258 may be incorporated into box 250 (e.g., to allow the thickness of wall 254 to be thinned). Metal structure 258 may, for example, be located over driver 256.

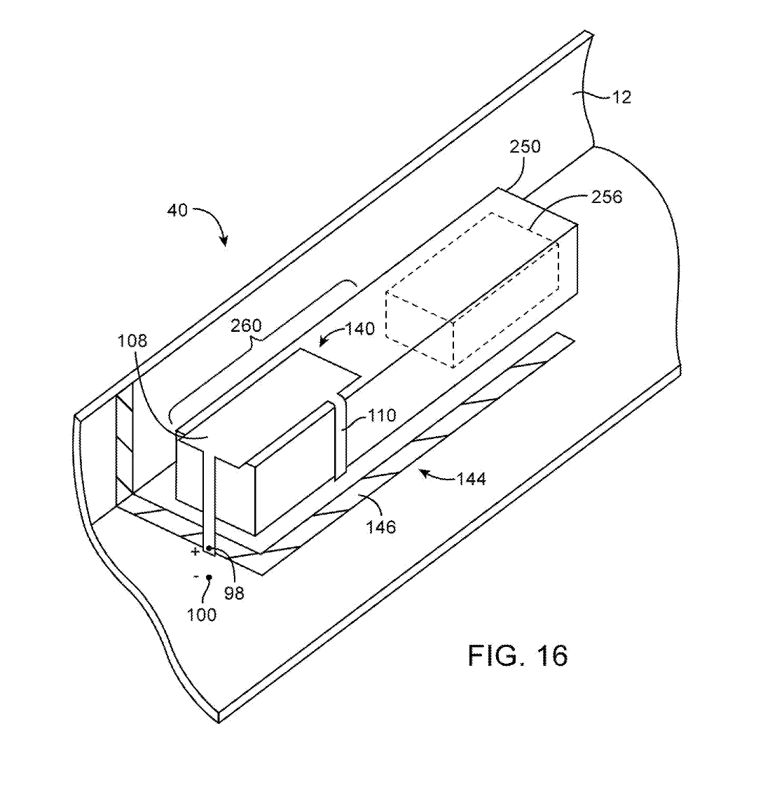

Antenna structures can be supported by speaker box 250. As shown in FIG. 16, for example, patch antenna resonating element 108 of planar inverted-F antenna structures 140 in antenna 40 may be supported by box 250 (e.g., in a portion of box 250 such as region 260 that does not overlap driver 256). Box 250 may run parallel to at least some of the portions of slot 146 in slot antenna structures 144. For example, box 250 may have an elongated shape that extends parallel to the edge of housing 12.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a housing having a metal wall; and
a hybrid planar inverted-F slot antenna, wherein the hybrid planar inverted-F slot antenna has slot antenna structures formed from a slot in the metal wall and has planar inverted-F antenna structures.

2. The electronic device defined in claim 1 further comprising an indirectly fed slot antenna.

3. The electronic device defined in claim 2 further comprising transceiver circuitry coupled to the hybrid planar inverted-F slot antenna to handle wireless local area network signals and coupled to the indirectly fed slot antenna to handle cellular telephone signals.

4. The electronic device defined in claim 1 wherein the planar inverted-F antenna structures include a resonating element formed from a metal patch.

5. The electronic device defined in claim 4 wherein the planar inverted-F antenna structures include a return path leg that extends between the metal patch and the metal wall.

6. The electronic device defined in claim 5 further comprising a plastic structure that supports the metal patch.

7. The electronic device defined in claim 6 wherein the plastic structure forms plastic walls for a speaker box.

8. The electronic device defined in claim 7 wherein the speaker box contains a speaker driver and wherein the metal patch does not overlap the speaker driver.

9. The electronic device defined in claim 8 wherein the slot has at least one bend.

10. The electronic device defined in claim 1 wherein the metal wall has a planar rear wall portion and sidewall portions and wherein the slot is an open slot formed at least partly in the planar rear wall portion and at least partly in the sidewall portions.

11. The electronic device defined in claim 10 further comprising plastic that fills the slot.

12. The electronic device defined in claim 11 wherein the slot has at least one bend.

13. A hybrid planar inverted-F slot antenna, comprising:
slot antenna structures formed from a slot in a metal electronic device housing wall; and
planar inverted-F antenna structures formed from a metal resonating element.

14. The hybrid planar inverted-F slot antenna defined in claim 13 wherein the metal electronic device housing wall includes a planar wall portion and wherein the metal resonating element lies in a plane that is parallel to the planar wall portion.

15. The hybrid planar inverted-F slot antenna defined in claim 14 wherein the slot has at least one bend and has a portion that extends along at least one sidewall portion of the metal electronic device housing wall.

16. The hybrid inverted-F slot antenna defined in claim 13 wherein the slot antenna structures are configured to exhibit an antenna resonance at 2.4 GHz and wherein the planar inverted-F antenna structures are configured to exhibit an antenna resonance at 5 GHz.

17. The hybrid inverted-F slot antenna defined in claim 13 further comprising a speaker box that supports the metal resonating element.

18. An electronic device, comprising:
a hybrid planar inverted-F slot antenna having slot antenna structures formed from a slot in a metal electronic device housing wall and having planar inverted-F antenna structures formed from a metal resonating element; and
an indirectly fed slot antenna.

19. The electronic device defined in claim 18 wherein the hybrid planar inverted-F slot antenna comprises a dual band wireless local area network antenna.

20. The electronic device defined in claim 19 wherein the indirectly fed slot antenna comprises a cellular telephone antenna having a slot formed in the metal electronic device housing wall.
